(19) United States
(12) Patent Application Publication
(10) Pub. No.: US 2006/0095280 A1
(43) Pub. Date: May 4, 2006

(54) Method and apparatus for paying for printing materials in a printer over the usage time of a printer cartridge

(75) Inventor: Darrell Raymond Gooding, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 10/980,465

(22) Filed: Nov. 3, 2004

(51) Int. Cl. G06Q 99/00

(52) U.S. Cl. 705/1

(57) ABSTRACT

An improved printing system is provided in which the toner or ink printing material is paid for in portions of a the total amount contained in an ink or toner cartridge. Only a portion of the printing material is authorized for use when the cartridge is new, and further amounts of the printing material can be authorized by a user entering into a transaction with a remote central station, which can provide the user with a coded message that may be entered via the printer's op-panel; or the central station can send an authorizing message directly to the printer via a network. The status of the current authorized amount can be stored in the printer's main memory, or on a memory chip located on the cartridge. Users can “pay as they go” to literally pay for the printing material over time or “usage,” in a manner similar to “installment payments.”

### TECHNICAL FIELD

The present invention relates generally to image forming equipment and is particularly directed to printers of the type which have cartridges that contain toner or ink. The invention is specifically disclosed as a printer that has a memory “smart chip” installed on a toner or ink cartridge, which can monitor the amount of toner or ink that remains in the cartridge, and which can allow a print job to occur, or inhibit a print job from occurring, depending upon whether or not a predetermined amount of toner or ink has been paid for by the user. Such a predetermined “paid” amount of toner/ink is considered to have been authorized for use by the printer; further amounts of the toner/ink within the cartridge would not be considered to have been authorized for use until those further amounts are later paid for.

A full toner/ink cartridge can be divided into several smaller amounts (or quantities) of printing material (i.e., the toner or ink), and each of these smaller amounts can be paid for, one at a time. A user can communicate with a central station (e.g., a “payment server”) to pay for a “next” amount of the printing material, so as to continue the operation of the printer. In this manner, the initial price of the toner or ink cartridge can be much less, and users can “pay as they go” to literally pay for the printing material over time (or over “usage”) in a manner similar to “installment payments.”

The user can use a network, such as the INTERNET®, to communicate with the central station, or can use a telephone link to communicate with the central station. The user could use a credit card, for example, or some type of company purchase order or a company credit account, to pay for the next amount of printer material. If the printer is connected to a network, then the central station could send an authorization message directly to the printer to enable it to allow its next amount of printing material to be used. Or, the user could personally go to the printer's site and enter an authorization message via the printer's op-panel, and thereby cause the printer to enable itself to allow its next amount of printing material to be used. The authorization message entered by the user would typically consist of a numeric code or an alphanumeric sequence that is generated by the central station, and accepted by the printer. Each such coded message could be quite different for each “next” quantity of printing material to be enabled. Of course, the printer controller with its computer program and stored memory information must be able to determine which messages would be accepted as being genuine authorization messages. The smart chip on the toner/ink cartridge could contain information that is required for the printer controller to determine such genuine authorization messages, or the printer main memory alone might contain such information needed for use in making such determinations.

The central station could be managed by the printer manufacturer, for example, and could keep track of the usage of the cartridges, by using the device serial numbers of the various printers, for example, that are part of the “pay as you go” system. As an alternative, the central station could be managed by a third party entity, for example, that might monitor printer usage (perhaps again by device serial number), and accept payments and send further usage authorization messages to various printers for many different manufacturers of printers that may be part of the “pay as you go” system. Either the printers, or the cartridges themselves (or both), may contain serial numbers that could be tracked by the “pay as you go” system.

### BACKGROUND OF THE INVENTION

In the past printers having replaceable cartridges of image-forming material have been authorized to use all of the material contained within that cartridge, whether it is an ink cartridge for an ink jet printer or a toner cartridge for a laser printer. Some of the cartridges can be rather expensive, especially for some of the larger capacity toner cartridges that can be placed in modern laser printers. Since some toner cartridges can be rather expensive, a company that owns or rents multiple laser printers may not want to store or keep in stock a large supply of toner cartridges, that otherwise might be desired to keep all of their printers adequately supplied, as they run through the toner in their existing cartridges. In that situation, a printer may run out of toner, and a new toner cartridge may not be immediately available, and will have to be ordered from a distributor or from the manufacturer.

It would be an improvement to allow a user or a company to buy a “full value” toner cartridge or ink cartridge, but not have to pay the “full price” of that toner/ink material at the outset.

### SUMMARY OF THE INVENTION

Accordingly, it is an advantage of the present invention to provide a method of allowing a user to purchase a container of image-forming material for a printer without having to pay the full price of that container.

It is another advantage of the present invention to provide a printing system for which containers of image-forming material can be paid for in “installment”-type payments, rather than having to pay the full price for that container of image-forming material at the outset.

It is yet another advantage of the present invention to provide a printing system that allows a user to make a payment to a payment-collecting entity, and then receive an authorization message so that a printer can become authorized to use a further portion of the image-forming material of a container, as the printer uses the material within that container for normal print job usage.

It is still another advantage of the present invention to provide a printing system that allows a user to make a payment to a payment-collecting entity and then receive an authorizing command that can be entered through the op-panel of the printer, thereby allowing the printer to continue to operate by authorizing a further amount of the image-forming material to be utilized by that printer.

Additional advantages and other novel features of the invention will be set forth in part in the description that follows and in part will become apparent to those skilled in the art upon examination of the following or may be learned with the practice of the invention.

To achieve the foregoing and other advantages, and in accordance with one aspect of the present invention, a method for controlling use of image-forming material in an image forming system is provided, in which the method comprises the following steps: (a) providing an image forming apparatus having a memory circuit for storage of data, a processing circuit, a printing station, and a container having a supply of image-forming material; (b) determining an amount of the image-forming material that has been authorized for use in the image-forming apparatus, based upon a pre-paid amount of the image-forming material, wherein the authorized amount may be less than a total amount of the image-forming material that is contained in the container; and (c) when a print job is received at the image forming apparatus, determining if there is any remaining of the authorized amount of the image-forming material, and: (i) if so, then printing the print job; (ii) if not, then inhibiting the print job until a further amount of the contained image-forming material is authorized.

In accordance with another aspect of the present invention, a method for controlling use of image-forming material in an image forming system is provided, in which the method comprises the following steps: (a) providing an image forming apparatus having a memory circuit for storage of data, a processing circuit, a printing station, and a container having a supply of image-forming material; (b) determining an amount of the image-forming material that has been authorized for use in the image-forming apparatus, based upon a pre-paid amount of the image-forming material, wherein the authorized amount may be less than a total amount of the image-forming material that is contained in the container; and (c) when a print job is received at the image forming apparatus, determining if a predetermined number of pages of the print job will require more than the authorized amount of the image-forming material, and: (i) if not, then printing the print job; (ii) if so, then inhibiting the print job until a further amount of the contained image-forming material is authorized.

In accordance with yet another aspect of the present invention, an image forming apparatus is provided, which comprises: a memory circuit for storage of data, a processing circuit, a printing station, and a container having a supply of image-forming material; wherein the processing circuit is configured: (a) to determine an amount of the image-forming material that has been authorized for use in the image-forming apparatus, based upon a pre-paid amount of the image-forming material, wherein the authorized amount may be less than a total amount of the image-forming material that is contained in the container; and (b) when a print job is received at the image forming apparatus, to determine whether or not the print job should be printed, depending upon the status of the authorized amount of the image-forming material.

In accordance with still another aspect of the present invention, a business method for paying for image-forming material in a printer is provided, in which the method comprises the following steps: (a) providing a printer having a memory circuit for storage of data, a processing circuit, a printing station, and a container having a supply of image-forming material; (b) determining an amount of the image-forming material that has been authorized for use in the printer, based upon a pre-paid amount of the image-forming material, wherein the authorized amount may be less than a total amount of the image-forming material that is contained within the container; and (c) when a print job is received at the printer, determining whether or not the print job should be printed, depending upon the status of the authorized amount of the image-forming material.

Still other advantages of the present invention will become apparent to those skilled in this art from the following description and drawings wherein there is described and shown a preferred embodiment of this invention in one of the best modes contemplated for carrying out the invention. As will be realized, the invention is capable of other different embodiments, and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification illustrate several aspects of the present invention, and together with the description and claims serve to explain the principles of the invention. In the drawings:

FIG. 1 is a block diagram of some of the major components of an electrophotographic (EP) printer, as constructed according to the principles of the present invention.

FIG. 2 is a diagrammatic view of a networked system that uses a printer and at least one computer that are in communication with a payment server, as according to the principles of the present invention.

FIG. 3 is a flow chart of some of the logical steps used in the present invention to determine if a print job should be printed with authorized image-forming material.

### DETAILED DESCRIPTION OF THE PREFERRED EMBODIMENT

Reference will now be made in detail to the present preferred embodiment of the invention, an example of which is illustrated in the accompanying drawings, wherein like numerals indicate the same elements throughout the views.

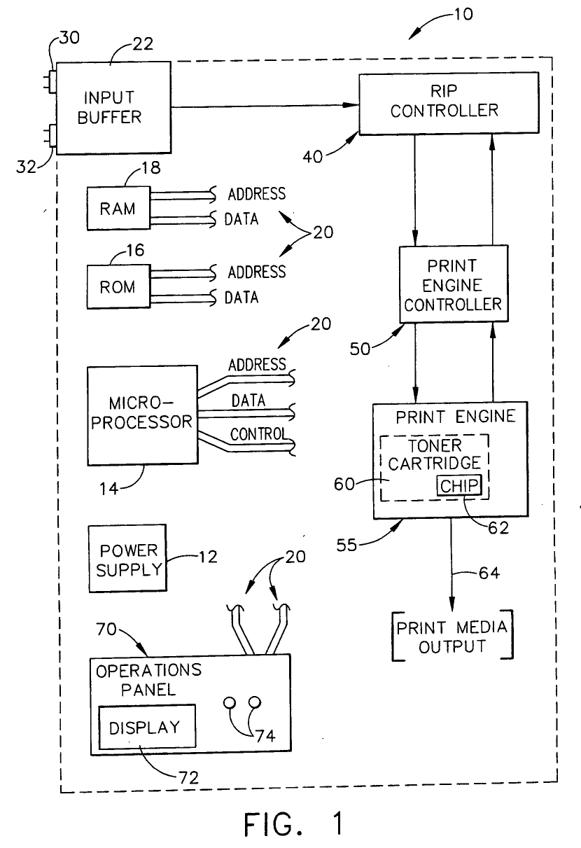

Referring now to the drawings, FIG. 1 is a hardware block diagram generally showing some of the main components of an electrophotographic (EP) printer, generally designated by the reference numeral 10. EP Printer 10 contains an electrical power supply 12, which typically receives AC voltage and outputs one or more DC voltages. The EP printer 10 also contains some type of processing circuit, such as a microprocessor or microcontroller 14, which typically has at least one address bus, one data bus, and perhaps one control bus or set of control signal lines, all generally designated by the reference numeral 20.

An EP printer 10 (e.g., a laser printer) would also contain memory elements, such as read only memory (ROM) 16 and random access memory (RAM) 18, which also would typically be in communication with an address bus and data bus, and typically connected through the buses 20 to the microprocessor or microcontroller 14.

Most printers receive print jobs from an external source, and in printer 10 there typically would be an input buffer 22 to receive print data, usually through at least one input port, such as the ports 30 and 32. In modern printers, a typical input port could be a USB port or a network ETHERNET port, but also other types of ports can be used, such as parallel ports and serial ports. The input buffer 22 can be part of the overall system RAM 18, or it can be a separate set of memory elements or data registers, if desired.

In many modern EP printers, additional memory devices are included, such as some type of bulk memory device, or Flash memory or NVRAM-type memory devices. In today's technology, the semiconductor non-volatile memory devices typically are constructed of electrically-erasable programmable read only memory (EEPROM) devices. A bulk memory device could comprise a hard disk drive, or perhaps an optical drive that has read/write capabilities.

When a print job arrives at the input buffer 22, it is passed to a raster image processor (RIP) stage, at reference numeral 40. The print job is typically divided into individual pages, and any rasterizing that may need to be performed will occur at this RIP stage 40. Once the print job has been divided into individual bitmaps that represent pages, the print data is then sent to a print engine controller, at reference numeral 50. It will be understood that, in many modern EP printers, an entire page of bitmap data is not necessarily available in its final rasterized form at the moment when the first scanline of bitmap data is sent to the print engine controller for that same page.

The print engine controller 50 controls all of the mechanical devices of a standard EP or laser print engine 55. In most sheet printers, there is at least one input paper tray (not shown) and, when needed, the print engine 55 actuates the input paper tray, and causes it to send a sheet of print media to the print engine 55, whereupon it is printed with toner. When the print engine 55 is finished with this particular sheet, the printed sheet is typically sent to an output paper tray, depicted on FIG. 1 by a “print media output” pathway 64. A toner cartridge 60 contains a supply of toner material; in many laser printers, the toner cartridge (or cartridges for many color laser printers) is removable, and can be replaced with a new toner cartridge that contains a fresh supply of toner.

In many conventional EP printers, there is a first ASIC for controlling the print raster imaging process and a separate (second) ASIC for controlling the print engine. In many newer conventional printers, the ASICs have become powerful enough that all of the elements which make up the rasterizer (image processor) and the print engine controller can be placed into a single ASIC package. The processing circuit and memory circuit elements may, or may not, be resident on the ASIC. The exact hardware configuration of these circuit components is not of critical importance in the present invention.

On FIG. 1, the toner cartridge 60 includes an integrated circuit chip 62. This represents a memory device, such as an EEPROM device that contains non-volatile memory locations. This chip on the toner cartridge is sometimes referred to as a “smart chip” because it provides extra capabilities for the toner cartridge 60, as well as the overall functions of the EP printer 10. In the present invention, the EEPROM chip 62 can store information regarding toner usage, which will be discussed below in greater detail.

FIG. 1 also includes an operator panel 70 that has capabilities for interfacing with a human user. The operator panel (also sometimes referred to as an “op-panel”) includes some type of electrical switches for the user to enter information to the printer 10. Such switches can be in the form of pushbuttons, such as the pushbuttons 74 on FIG. 1. In many printers, some type of display is used, such as an LCD display or a group of LEDs, or other type of flat panel display. On FIG. 1, the display is generally designated by the reference numeral 72.

For the purposes of the present invention, the main functional hardware depicted in FIG. 1 for an EP printer can also be used for other types of printers, such as ink jet printers. An ink jet printer will also include an input buffer, some type of microprocessor, a power supply, and memory elements, such as RAM and ROM. An ink jet printer will also include some type of raster image processing controller and a printhead controller (instead of a “print engine” controller) that controls a moveable carriage which contains an ink cartridge with multiple nozzles that discharge ink droplets.

A printhead controller is very similar to a print engine controller with regard to many of the final functions that are required, although the mechanical components are certainly different. The toner cartridge 60 of FIG. 1 would be replaced by an ink cartridge for an ink jet printer. Image-forming material will be necessary for either type of printer to create text or images on the print media that is output from either type of printer. In general, the ink cartridges of an ink jet printer are typically replaceable, so that when the printer's existing ink cartridge runs low on ink, a new cartridge can be used to replace the old cartridge, and thereby provide a fresh supply of ink. This includes both black ink and colored ink, typically CMY (cyan, magenta, yellow) colors.

A print engine and a printhead both include “printing stations” for their particular type of printing apparatus. The term “printing station” is used in the claims, and represents the portion of an image forming apparatus that actually imparts the image-forming material onto the print media. Thus, the term “printing station” can include portions or all of a printhead, carriage, and platen for an ink jet printer, or the laser light source, rotating mirror, photoconductive drum, backup rollers, and fuser of a laser printer.

For the purposes of the present invention, the replaceable cartridge is often referred to as a “container” herein, particularly in the claims. A toner cartridge and an ink cartridge are both “containers” for the purposes of the present invention. Moreover, both types of containers will contain a supply of “image-forming material,” which is the terminology used in the claims for materials or substances such as toner or ink.

In the present invention, a full value of image-forming material usually is initially provided in some type of container, such as a toner cartridge or an ink cartridge. The full value containers are supplied in a manner that allows the user to pay for the “full value” of the consumable material therewithin in customer-selectable increments. In this manner, a user can purchase a toner cartridge, for example, that has a full supply of toner, but at the time of this initial purchase, the user need only pay for a portion of that toner material. After a predetermined amount of consumption of the toner, the printer will stop operating until the user pays for the next installment amount (or quantity) of the image-forming material (i.e., toner). Once the printer has become aware that an additional amount of the image-forming material has been purchased, then the printer will continue to operate for the user.

When a printer is first purchased, a certain portion of the toner or ink within the replaceable container of image-forming material may be considered as being “pre-paid,” or the printer can be sold such that none of the image-forming material can be used until the user makes an initial payment by contacting some type of “payment-collecting entity” that receives payments and keeps records of the usage of the toner or ink materials in the printer, or of the container itself. The payment-collecting entity can also be an “authorizing entity” that provides information to the user so that the user may continue (or begin) using the printer with its container of image-forming material. As a minimum, an initial amount of the image-forming material needs to be “authorized,” and typically in the present invention, the “authorized amount” of the image-forming material will be less than the “total amount” of the image-forming material that is contained within a new toner cartridge or ink cartridge.

In general, once an authorized amount of the image-forming material has been used, the printer will stop operating until a further portion of the remaining image-forming material becomes authorized. In the present invention, the methodology of obtaining authorization for usage of further amounts of the image-forming material that exists in the container can take several forms. One form is to have the printer communicate with some type of “payment server” that can be contacted over a computer network, such as the INTERNET. The user at a personal computer on the same network with the printer can pass messages to and from such a payment server, and the payment server can send an authorizing message directly to the printer; at that point the printer can then automatically enable a “next” or further amount of the image-forming material for use by that printer. In another method or form, the human user makes a telephone call or otherwise communicates with a payment server or other type of payment-collecting entity, and the user can receive some type of command or code that can be entered via the op-panel of the printer. Once the printer receives a proper such authorizing command or code, then a further amount of the image-forming material becomes authorized for use by that printer.

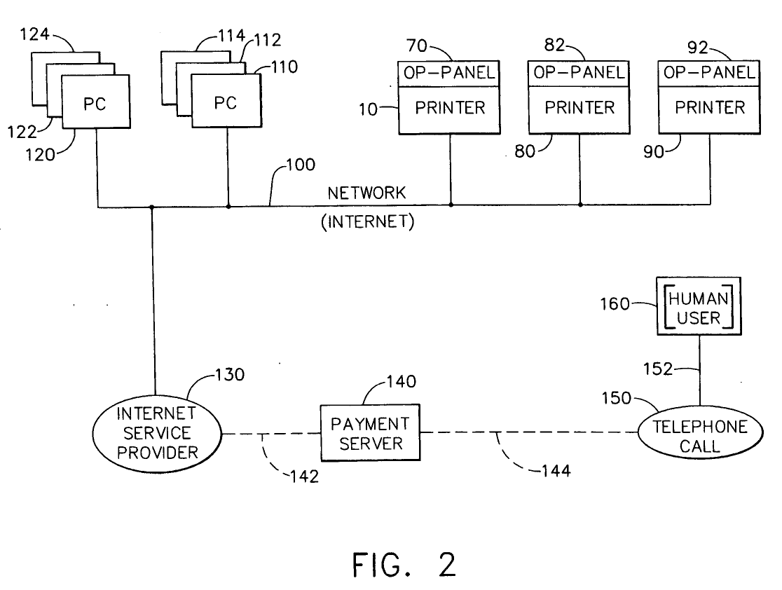

Referring now to FIG. 2, printer 10 is illustrated as being connected to a network 100, in which such network could be part of an intranet within a company, but also connected to the INTERNET through an internet service provider (or ISP) 130. Other printers can also be connected on this same network 100, such as a printer 80 and a printer 90, each having some type of operator panel 82 or 92, respectively. In addition, one or more user personal computers or workstations can be connected to the same network 100, which are diagrammatically indicated by the blocks named “PC” at 110, 112, 114, 120, 122, and 124.

In one form of the present invention, any one of the users at the PCs listed above could be empowered to provide information to an authorizing entity, and thereby either receive information from an authorizing entity, or have a message downloaded to a printer that needs a further amount of the remaining image-forming material in the particular printer to become authorized for further use by that printer. Alternatively, only certain personnel could be authorized to act in this manner, such as a systems administrator for the network 100.

In FIG. 2, a “payment server” is generally designated by the reference numeral 140. This payment server can be accessed over the INTERNET through the ISP 130, in one form of the present invention. The data link between the ISP 130 and the payment server 140 is designated by the reference numeral 142, and can include any type of communications link that can support electronic messages, including packet switched messages such as those commonly found over the INTERNET. When using that mode of receiving authorizations, one or more users at one of the PCs on the network 100 can access the payment server 140 to make a new payment for one of the printers 10, 80, or 90. This act of making a payment will then cause the payment server 140 to send an authorizing message to the appropriate printer, and that authorizing message can be automatically downloaded to the printer and construed by the printer's print controller, which will thus allow a further amount of the image-forming material to become authorized for use by that printer.

In an alternative mode of the present invention, one of the users or a systems administrator can contact the payment server 140 through a telephone or other type of communications channel that does not use the network 100 itself (such as the INTERNET). In FIG. 2, a human user 160 can make a telephone call (generally designated by the reference numeral 150) through a telephone line 152. The telephone network will then further transfer the call to the payment server 140 through the telephone network 144. The user can communicate with the payment server to first make a payment for the image-forming material container of a particular printer, and then to receive a communication from the payment server 140 that would be in the form of some type of coded message or command that the human user can enter into the op-panel of that same printer.

As discussed above, the op-panel 70 of printer 10 will include some type of input device, such as an electrical switch or a set of keypad buttons that will actuate some type of electrical contacts or optoelectronic circuits, for example. The op-panel 70 would also preferably have some type of display so that the user 160 can literally see the data being entered, and thus verify that the proper coded message or command is being received into the printer 10. This input message typically would be in the form of an authorization code from the payment server 140, which is acting as an “authorizing entity” in this situation. Of course, the payment server 140 was also acting as a “payment-collecting entity” to receive the payment from the human user.

The form of the communication between the payment server 140 and the human user 160 does not necessarily have to be a voice telephone call. Other forms could be used instead, such as messages sent in both directions using fax machines, or using e-mail messages between both the human user and the payment server, either in one direction or in both directions. For example, the human user could send an e-mail transmission to the payment server authorizing a payment using a certain message such as a company purchase order or a company's credit account, or perhaps the user could use an individual credit card or a company credit card, for example. The payment server 140 could then respond with a fax machine transmission to the user, or even with a voice telephone call, if desired.

A further option is for the user 160 to enter into a real time transaction on-line, using the INTERNET, for example. This would be a different type of INTERNET transaction, in which the user sends appropriate information to make a payment to the payment server 140, and the payment server 140 sends back a message for the human user to use as a command or coded message to be entered at the op-panel of one of the printers. This type of message from the payment server 140 would perhaps be different than the type of message sent through the ISP 130 that would then be communicated directly to the printer. On the other hand, both forms of messages from the payment server that are sent on-line could be the exact same type of coded command-type message, if desired. The system could be set up for any number of different types of messages, using encryption techniques to make these transactions secure.

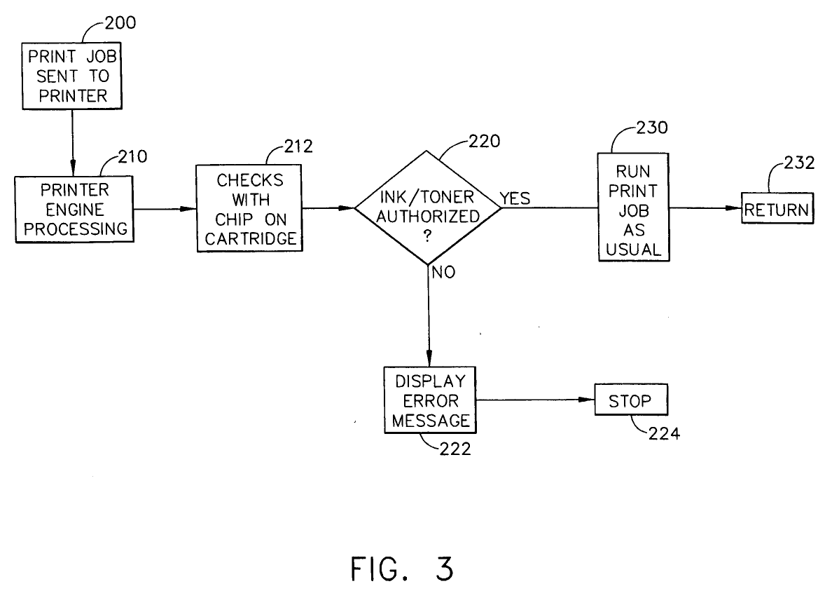

Referring now to FIG. 3, a flow chart is provided showing some of the steps used by the printer of the present invention. Starting at a step 200, a print job is sent to the printer and received, and at a step 210 the print engine begins processing. The print engine, at a step 212, now checks with the memory chip 62 on toner cartridge 60 to see what the status is of the image-forming material, in this case toner. A decision step 220 now determines whether or not the printer should be authorized to print this print job, and if the answer is NO, a step 222 will display an error message stating in effect that the printer has not been enabled to print using the existing toner material within the cartridge. The logic flow now arrives at a “stop” step 224, and the printer essentially is halted. A further amount (quantity) of image-forming material (e.g., toner) must first be enabled, to continue.

On the other hand, if the print job is authorized at step 220, then a step 230 runs the print job as a normal or “usual” job, and the document is printed. The logic flow then arrives at a “return” step 232, which ends this routine. In the flow chart of FIG. 3, the information on the “smart chip” that is mounted to the toner cartridge 60 determines whether or not the printing or image-forming material will be authorized to print the next print job that is now arriving at the printer. Such determining information could instead be stored in the memory of the main body of the printer 10, if desired. This could be one of the memory locations in the RAM 18, or perhaps in a non-volatile memory location if a Flash memory or if NVRAM is used in this printer 10.

The actual determination as to whether the image-forming material should be authorized or not can depend on more than one factor. For example, in one mode of the present invention, if any authorized material remains in the container (e.g., the toner cartridge 60), then the print job can be enabled, and thus printed. On the other hand, the RIP controller 40 and/or the print engine controller 54 can inspect the actual print data for the incoming print job and then determine how much of the image-forming material will be required to print the first page. If enough image-forming material is required that will deplete the previously authorized amount of the image-forming material, then the print job could be disabled or inhibited, and thus not printed.

As a further alternative, the RIP controller 40 and/or print engine controller 54 could look at further portions of the print job, or even the entire print job, if that information is available to the printer 10. If the entire print job, for example, cannot be printed without depleting all of the previously authorized amount of the image-forming material, then that print job could be disabled or inhibited, if desired. This last mode of the present invention may not always be realistically possible, since in many modern EP printers, and in virtually all ink jet printers, the printer will not necessarily be aware of the entire print job's contents as the first page of data arrives. Of course, some combination of the above determining schemes could be utilized, without departing from the principles of the present invention.

In the flow chart of FIG. 3, step 212 inspects the memory chip on the cartridge, which is a preferred mode of the present invention. This memory chip 62 can contain various important information about a toner cartridge or an ink cartridge, for example. Such information can include the total amount of image-forming material that was supplied in the cartridge when it was new, and can keep track of the usage of the image-forming material as print jobs are received by the printer to which this cartridge 60 is attached. The memory chip 62 can also contain information as to how much of the image-forming material has been authorized for use by the printer. Moreover, the memory elements of this chip 62 can contain the serial number of the cartridge itself, if desired, which will enable the payment server 140 to track the use of this cartridge, regardless as to whether it is used in one or more printers throughout its history. It may also be able to determine whether or not the cartridge has been refilled by an authorized refiller.

Some or all of the above information can also be stored in the main body of the printer 10, and the authorized amounts can be checked against a printer's serial number as well as the serial number of the cartridge. If desired, the printer's serial number can be used to keep track of which cartridges have been installed therein, although that is not necessarily an important function of the present invention. It is more important that the user he allowed to use the amount of toner or ink that has been paid for in a particular cartridge, and therefore, it would probably be better if the payment server 140 keeps track of the individual cartridges, regardless as to which printer(s) they may be used with.

The op-panel display can be used by a user to readily display the status of the image-forming material that remains in the container or cartridge of the printer. One item of information could be for the remaining amount of the authorized material to be displayed or otherwise indicated, so the user has an idea as to when the next payment must be made to the payment-collecting entity (i.e., a payment server 140, or the like). The op-panel display could also be provided with functions that will lead the user through an easy supply replenishment process, so that making payments is user-friendly. Similar user-friendly display screens can be provided on the printer driver software that is installed on one or more of the computers or workstations that are attached to the network 100.

The system could even be set up so that a network server attached to one of the PCs would automatically make payments to the payment server 140 every time one of the printers on the network gets to a point where it needs a further authorized amount of the image-forming material. This could be a fully automatic system that would be set up by the systems administrator. Once it has been set up, there would be no necessary intervention by a human at all, except to provide a new toner cartridge that is to be installed on a printer for the first time. Even that can be fairly automated, because the smart chip of certain toner cartridges (e.g., certain toner cartridges provided on Lexmark International, Inc. laser printers, for example) can contain the identification and usage information required by the payment server, and the printer's main controller could be enabled to communicate with that payment server when a fresh toner cartridge has first been installed. There are many possible ways that the printer and the image-forming material container can interact with one another, and also interact with a payment server, to implement the principles of the present invention.

It will be understood that the term “print media” herein refers to a sheet or roll of material that has toner or some other “printable” material applied thereto by a print engine, such as that found in a laser printer, or other type of electrophotographic printer. Alternatively, the print media represents a sheet or roll of material that has ink or some other “printable” material applied thereto by a print engine or printhead, such as that found in an ink jet printer, or which is applied by another type of printing apparatus that projects a solid or liquified substance of one or more colors from nozzles or the like onto the sheet or roll of material. Print media is sometimes referred to as “print medium,” and both terms have the same meaning with regard to the present invention, although the term print media is typically used in this patent document. Print media can represent a sheet or roll of plain paper, bond paper, transparent film (often used to make overhead slides, for example), or any other type of printable sheet or roll material.

As used herein, the terms “printable material” and “image-forming material” represent substances used by printers to create text and images on the print media, and such substances are typically referred to as “toner” or “ink” in modern laser printers and ink jet printers, respectively. These terms are also meant to include other forms of consumable materials or substances that are used by copiers and printers (and the like) to form images of any type, and upon any type of print media, including materials/substances that have not yet come into existence as of the date of the present invention.

It will also be understood that the logical operations described in relation to the flow charts of FIG. 3 can be implemented using sequential logic, such as by using microprocessor technology, or using a logic state machine, or perhaps by discrete logic; it even could be implemented using parallel processors. One preferred embodiment may use a microprocessor or microcontroller (e.g., microprocessor 14) to execute software instructions that are stored in memory cells within an ASIC. In fact, the entire microprocessor 14 along with dynamic RAM and executable ROM may be contained within a single ASIC. Of course, other types of circuitry could be used to implement these logical operations depicted in the drawings without departing from the principles of the present invention.

It will be further understood that the precise logical operations depicted in the flow charts of FIG. 3, and discussed above, could be somewhat modified to perform similar, although not exact, functions without departing from the principles of the present invention. The exact nature of some of the decision steps and other commands in these flow charts are directed toward specific future models of laser printer systems (those involving Lexmark printers with smart chips on their toner cartridges, for example) and certainly similar, but somewhat different, steps would be taken for use with other types or manufacturers of printing systems in many instances, with the overall inventive results being the same.

All documents cited in the Detailed Description of the Invention are, in relevant part, incorporated herein by reference; the citation of any document is not to be construed as an admission that it is prior art with respect to the present invention.

The foregoing description of a preferred embodiment of the invention has been presented for purposes of illustration and description. It is not intended to be exhaustive or to limit the invention to the precise form disclosed. Any examples described or illustrated herein are intended as non-limiting examples, and many modifications or variations of the examples, or of the preferred embodiment(s), are possible in light of the above teachings, without departing from the spirit and scope of the present invention. The embodiment(s) was chosen and described in order to illustrate the principles of the invention and its practical application to thereby enable one of ordinary skill in the art to utilize the invention in various embodiments and with various modifications as are suited to particular uses contemplated. It is intended to cover in the appended claims all such changes and modifications that are within the scope of this invention.

The invention claimed is:

1. A method for controlling use of image-forming material in an image forming system, said method comprising:
(a) providing an image forming apparatus having a memory circuit for storage of data, a processing circuit, a printing station, and a container having a supply of image-forming material;
(b) determining an amount of said image-forming material that has been authorized for use in the image-forming apparatus, based upon a pre-paid amount of said image-forming material, wherein said authorized amount may be less than a total amount of said image-forming material that is contained in said container; and
(c) when a print job is received at said image forming apparatus, determining if there is any remaining of said authorized amount of the image-forming material, and:
(i) if so, then printing the print job;
(ii) if not, then inhibiting the print job until a further amount of said contained image-forming material is authorized.

2. The method as recited in claim 1, further comprising the step of: authorizing a further amount of said contained image-forming material by receiving a message through a communications port of said image forming apparatus.

3. The method as recited in claim 2, wherein said communications port is in communication with an authorizing entity, through a computer network.

4. The method as recited in claim 3, wherein:
said authorizing entity comprises a payment-collecting entity that receives payments and keeps records of said authorized amount of image-forming material for said image forming apparatus; and
said network comprises the INTERNET.

5. The method as recited in claim 1, further comprising the step of: authorizing a further amount of said contained image-forming material by a user entering a command at an input device of said image forming apparatus.

6. The method as recited in claim 5, wherein said input device comprises an operator panel having: (i) at least one input switching device for actuation by said user, and (ii) a display device for indicating a value of said command being input by said user.

7. The method as recited in claim 5, further comprising the steps of: said user receiving an authorization code from an authorizing entity, and entering said authorization code as said command at said input device.

8. The method as recited in claim 7, wherein:
said authorizing entity comprises a payment-collecting entity that receives payments and keeps records of said authorized amount of image-forming material for said image forming apparatus; and
said step of receiving an authorization code comprises said user being in communication with the authorizing entity using at least one of: (i) a voice telephone call; (ii) a fax machine transmission; (iii) an e-mail transmission; and (iv) an on-line real time transaction.

9. The method as recited in claim 1, wherein a status of said authorized amount of the image-forming material is stored in said memory circuit, either on a main body portion of said image forming apparatus, or on a memory chip located on said container, or both.

10. A method for controlling use of image-forming material in an image forming system, said method comprising:
(a) providing an image forming apparatus having a memory circuit for storage of data, a processing circuit, a printing station, and a container having a supply of image-forming material;
(b) determining an amount of said image-forming material that has been authorized for use in the image-forming apparatus, based upon a pre-paid amount of said image-forming material, wherein said authorized amount may be less than a total amount of said image-forming material that is contained in said container; and
(c) when a print job is received at said image forming apparatus, determining if a predetermined number of pages of said print job will require more than said authorized amount of the image-forming material, and:
(i) if not, then printing the print job;
(ii) if so, then inhibiting the print job until a further amount of said contained image-forming material is authorized.

11. The method as recited in claim 10, further comprising the step of: authorizing a further amount of said contained image-forming material by receiving a message through a communications port of said image forming apparatus.

12. The method as recited in claim 11, wherein said communications port is in communication with an authorizing entity, through a computer network; and said authorizing entity comprises a payment-collecting entity that receives payments and keeps records of said authorized amount of image-forming material for said image forming apparatus.

13. The method as recited in claim 10, further comprising the step of: authorizing a further amount of said contained image-forming material by a user entering a command at an input device of said image forming apparatus.

14. The method as recited in claim 13, further comprising the steps of: said user receiving an authorization code from an authorizing entity, and entering said authorization code as the command at said input device.

15. The method as recited in claim 14, wherein:
said authorizing entity comprises a payment-collecting entity that receives payments and keeps records of said authorized amount of image-forming material for said image forming apparatus; and
said step of receiving an authorization code comprises said user being in communication with the authorizing entity using at least one of: (i) a voice telephone call; (ii) a fax machine transmission; (iii) an e-mail transmission; and (iv) an on-line real time transaction.

16. The method as recited in claim 10, wherein said step of determining if a predetermined number of pages of said print job will require more than said authorized amount of the image-forming material comprises one of: (i) determining if a first page of said print job will require more than said authorized amount; and (ii) determining if said entire print job will require more than said authorized amount.

17. The method as recited in claim 10, wherein a status of said authorized amount of the image-forming material is stored in said memory circuit, either on a main body portion of said image forming apparatus, or on a memory chip located on said container, or both.

18. An image forming apparatus, comprising:
a memory circuit for storage of data, a processing circuit, a printing station, and a container having a supply of image-forming material;
wherein said processing circuit is configured: (a) to determine an amount of said image-forming material that has been authorized for use in the image-forming apparatus, based upon a pre-paid amount of said image-forming material, wherein said authorized amount may be less than a total amount of said image-forming material that is contained in said container; and (b) when a print job is received at said image forming apparatus, to determine whether or not said print job should be printed, depending upon the status of said authorized amount of the image-forming material.

19. The image forming apparatus as recited in claim 18, wherein a status of said authorized amount of the image-forming material is stored in said memory circuit, either on a main body portion of said image forming apparatus, or on a memory chip located on said container, or both.

20. The image forming apparatus as recited in claim 18, wherein said processing circuit is further configured to determine at least one of: (c) whether or not there is any remaining of said authorized amount of the image-forming material; (d) whether or not there is sufficient remaining of said authorized amount of the image-forming material to print the entire of said print job; and (e) whether or not there is sufficient remaining of said authorized amount of the image-forming material to print at least one page of said print job.

21. The image forming apparatus as recited in claim 18, wherein: if said status of the authorized amount of the image-forming material indicates that said print job should not be printed, then said processing circuit is further configured to inhibit the print job until a further amount of said contained image-forming material is authorized.

22. The image forming apparatus as recited in claim 18, further comprising a communications port that receives a message; and
wherein said processing circuit is further configured to inspect said message and, if the message is proper, to authorize a further amount of said contained image-forming material for use by said image forming apparatus.

23. The image forming apparatus as recited in claim 22, wherein said communications port is in communication with an authorizing entity, through a computer network.

24. The image forming apparatus as recited in claim 23, wherein:
said authorizing entity comprises a payment-collecting entity that receives payments and keeps records of said authorized amount of image-forming material for said image forming apparatus; and
said network comprises the INTERNET.

25. The image forming apparatus as recited in claim 18, further comprising an input device that allows a user to enter a command to said image forming apparatus; and
wherein said processing circuit is further configured to inspect said entered command and, if the command is proper, to authorize a further amount of said contained image-forming material for use by said image forming apparatus.

26. The image forming apparatus as recited in claim 25, wherein said input device comprises an operator panel having: (i) at least one input switching device for actuation by said user, and (ii) a display device for indicating a value of said command being input by said user.

27. The image forming apparatus as recited in claim 25, wherein said user receives an authorization code from an authorizing entity, and said user enters said authorization code as the command at said input device.

28. The image forming apparatus as recited in claim 27, wherein:
said authorizing entity comprises a payment-collecting entity that receives payments and keeps records of said authorized amount of image-forming material for said image forming apparatus; and
said user receives an authorization code from the authorizing entity by way of at least one of: (i) a voice telephone call; (ii) a fax machine transmission; (iii) an e-mail transmission; and (iv) an on-line real time transaction.

29. A business method for paying for image-forming material in a printer, said method comprising:
(a) providing a printer having a memory circuit for storage of data, a processing circuit, a printing station, and a container having a supply of image-forming material;
(b) determining an amount of said image-forming material that has been authorized for use in said printer, based upon a pre-paid amount of said image-forming material, wherein said authorized amount may be less than a total amount of said image-forming material that is contained within said container; and
(c) when a print job is received at said printer, determining whether or not said print job should be printed, depending upon the status of said authorized amount of the image-forming material.

30. The method as recited in claim 29, wherein said step of determining whether or not the print job should be printed comprises one of:
(i) whether or not there is any remaining of said authorized amount of the image-forming material;
(ii) whether or not there is sufficient remaining of said authorized amount of the image-forming material to print the entire of said print job; and
(iii) whether or not there is sufficient remaining of said authorized amount of the image-forming material to print at least one page of said print job.

31. The method as recited in claim 29, wherein: if said step of determining whether or not the print job should be printed decides that the print job should not be printed, then further comprising the step of:
inhibiting the print job until a further amount of said contained image-forming material is authorized by a remotely-located payment-collecting entity.

32. The method as recited in claim 31, further comprising the step of: authorizing a further amount of said contained image-forming material by receiving a message from said remotely-located payment-collecting entity, over a computer network.

33. The method as recited in claim 31, further comprising the step of:
keeping records, at said remotely-located payment-collecting entity, of said authorized amount of image-forming material for said printer.

34. The method as recited in claim 29, further comprising the step of: authorizing a further amount of said contained image-forming material by a user entering a command at an input device of said printer.

35. The method as recited in claim 34, further comprising the steps of: said user receiving an authorization code from a remotely-located payment-collecting entity, and entering said authorization code as the command at said input device.

36. The method as recited in claim 35, further comprising the steps of:
keeping records, at said remotely-located payment-collecting entity, of said authorized amount of image-forming material for said printer; and
using at least one of: (i) a voice telephone call; (ii) a fax machine transmission; (iii) an e-mail transmission; and (iv) an on-line real time transaction, for said step of the user receiving an authorization code from said remotely-located payment-collecting entity.

37. The method as recited in claim 29, wherein a status of said authorized amount of the image-forming material is stored in said memory circuit, either on a main body portion of said image forming apparatus, or on a memory chip located on said container, or both.
